(19) United States
(12) Patent Application Publication
(10) Pub. No.: US 2008/0037188 A1
(43) Pub. Date: Feb. 14, 2008

(54) SURGE SUPPRESSION SYSTEM FOR POWER OVER NETWORK CABLES

(75) Inventors: James A. Wilson, Post Falls, ID (US); Daniel J. Sullivan, Post Falls, ID (US); Richard R. Chadwick, Post Falls, ID (US)

Correspondence Address: MARGER JOHNSON & MCCOLLOM, P.C., 210 SW MORRISON STREET, SUITE 400, PORTLAND, OR, 97204, US

(73) Assignee: A.C. DATA SYSTEMS OF IDAHO, INC., Post Falls, ID (US)

(21) Appl. No.: 11/837,271

(22) Filed: Aug. 10, 2007

Related U.S. Application Data
(60) Provisional application No. 60/822,180, filed on Aug. 11, 2006.

(51) Int. Cl. H02H 9/04

(52) U.S. Cl. 361/56

(57) ABSTRACT

A surge suppression unit comprises connection circuitry for coupling the surge suppression unit in a communication cable. Surge suppression circuitry uses Silicon Avalanche Diodes (SADs) that couple power surges on the communication cable to ground. In one embodiment, the surge suppression unit includes multiple surge suppression modules configured for inserting into different slots in a same enclosure. The surge suppression modules can be quickly and easily inserted and then removed for connection with different communication cables

### CROSS-REFERENCE TO RELATED APPLICATION

The present application claims priority from U.S. Provisional Patent Application Ser. No. 60/822,180, filed Aug. 11, 2006, incorporated herein by reference in its entirety for all purposes.

### BACKGROUND

Surge suppressors are used to protect electronic equipment connected to a power line or data cable from voltage surges. Surge suppressors operate by providing an alternate electrical pathway having lower resistance for voltages exceeding a certain desired threshold. Providing an easier pathway for excess voltages prevents these voltage “surges” or “spikes” from traveling into and damaging electronic equipment connected to the AC circuit or data cable. Typical surge suppressors use Metal Oxide Varistors (MOVs) or Silicon Avalanche Diodes (SAD) to provide this alternate pathway.

In a surge suppression assembly, the MOV or SAD surge suppression circuits are connected to a bus bar. The bus bar provides an electrical coupling between a surge suppression circuit and an external contact such as a power line, a neutral line, or a ground. The bus bars must generally be placed on separate planes in order to secure an electrical coupling between them.

Conventional surge suppressors are generally not expandable to accommodate additional suppression needs. If, for example, a consumer using a conventional surge suppressor develops an increased need for surge suppression, in order to obtain a surge suppressor with a larger suppression capacity, they typically have to buy a completely new surge suppression assembly. Consumers are unable to simply upgrade their current surge suppressors to increase capacity.

Conventional surge suppressors are also bulky and inefficient in their use of box space. Also, existing surge suppression assemblies are not capable of swapping out damaged or destroyed surge suppression modules without disrupting the operation of other surge suppression modules that may currently be operating in the same enclosure.

Some packet switched networks provide power over the same cables used for transferring data. These types of network connections are referred to generally as Power Over Ethernet (PoE) systems and either overlay power over the same wires used for carrying date packets or alternatively use separate wires in the cable for data transfer and for remote device power.

Surge suppression systems have been developed for these PoE networks. However, existing PoE surge suppression systems have power clamping limitations. Existing PoE surge suppression systems can limit the amount of rated power that can be supplied to network devices.

The present invention addresses this and other problems associated with the prior art.

### SUMMARY OF THE INVENTION

A Power over Ethernet (PoE) surge suppression system uses Schottky diodes to improve voltage clamping. In addition, Metal Oxide Varistors (MOVs) are used on separate PoE power conductors to provide increased power transmission. In one embodiment, a surge suppression unit includes multiple surge suppression modules configured for inserting into different slots in a same enclosure. The surge suppression modules can be quickly and easily inserted and then removed for connection with different communication cables.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a front view of a surge suppression device.

FIGS. 2A and 2B are top views for two alternative embodiments of the surge suppression device shown in FIG. 1.

FIG. 3 is a perspective view of the surge suppression device with a top lid removed.

FIG. 4A is an inverted isolated view of co-planar surge suppression modules attached to a bus bar contained inside the surge suppression device.

FIG. 4B is a side-by-side embodiment of the surge suppression modules.

FIG. 5 is a side view of one of the surge suppression modules.

FIG. 6 is a circuit diagram for surge suppression circuitry used in the surge suppression modules.

FIGS. 7, 8, and 11 show a modular Power over Ethernet (PoE) surge suppression system.

FIGS. 9 and 10 show an alternative embodiment of the PoE surge suppression system.

FIG. 12 shows power surge responses for Schottky diodes used in the PoE surge suppression systems shown in FIGS. 7-11.

### DETAILED DESCRIPTION

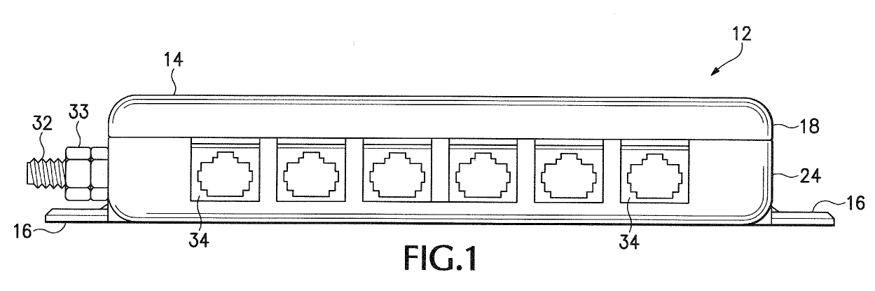

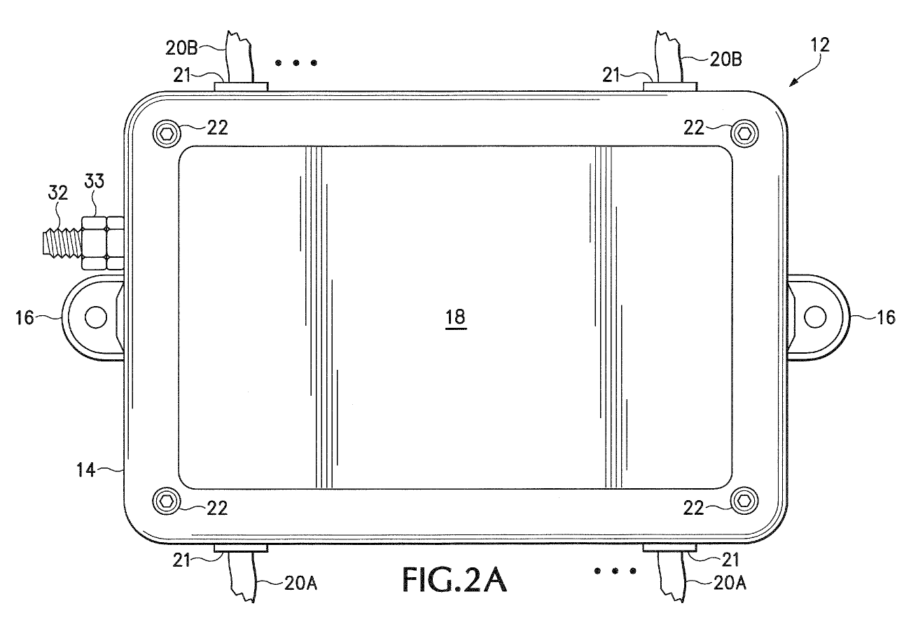

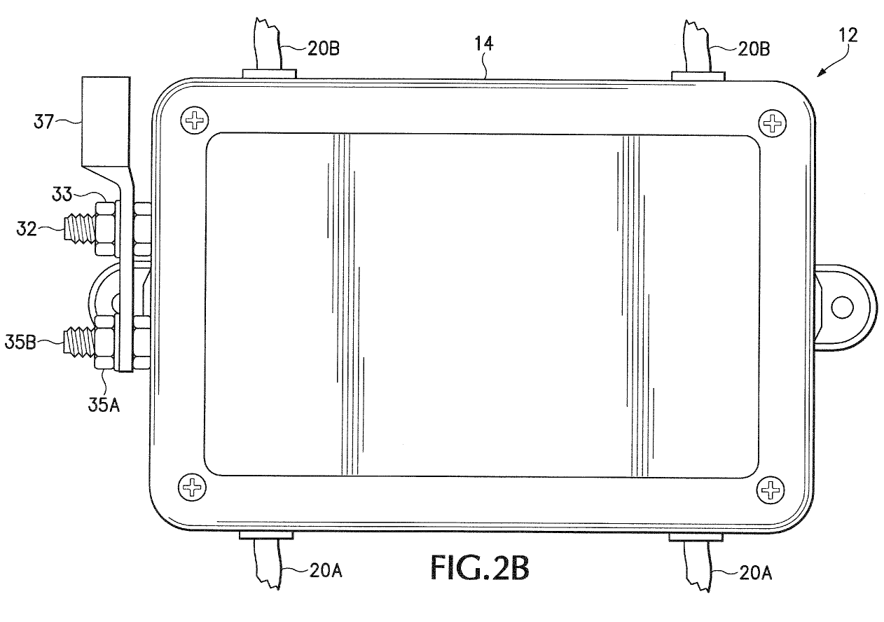

FIGS. 1 and 2A show a front and top view, respectively, of a surge suppression device 12. A back view of the surge suppression device 12 is substantially the same as the front view shown in FIG. 1. The surge suppression device 12 includes an enclosure 14 that in one embodiment is made of plastic. However, the enclosure 14 can be made out of any material including metal. Two tongues 16 on opposite sides of the enclosure 14 include holes for attaching the surge suppression device 12 to a wall.

A top lid 18 of the enclosure 14 is removable for inserting and removing individual surge suppression modules 30 shown in more detail below in subsequent figures. The lid 18 is attached to a bottom section 24 by screws 22.

The surge suppression device 12 is attached to different data cables 20 to prevent electrical power surges from damaging electrical equipment. In one specific application, the surge suppression module 12 is used to dissipate electrical power surges on telecommunication cables, such as the cables 20A and 20B shown in FIG. 2. For example, the cables 20A and 20B may be a T1 or E1 voice/data communication cables. In an alternative embodiment, the cables 20A and 20B can be for Plain Old Telephone Service (POTS) analog telephone lines. However, the surge suppression module 12 is easily adapted to accept any other type of cabling for any other type of electrical equipment. For example, in an alternative embodiment, the same or a similar surge suppression enclosure 14 can be used for connecting to Ethernet and/or Power over Ethernet (PoE) cables as will be described in more detail below.

In another embodiment, the connectors 34 can be replaced with hardwired terminals that have a screw that clamps directly onto the wires in the cable.

A first part of each cable 20A is connected to the front end of the surge suppression device 12 and a second part of each cable 20B is connected to a back end of the surge suppression device 12. Multiple individual surge suppression modules 30 inside the surge suppression device 12 direct power surges detected on either end 20A and 20B of the different cables to ground. This prevents the power surge from reaching and destroying electrical equipment connected to the cables 20A and 20B.

Multiple female connectors 34 (FIG. 1) are aligned on both the front and back end of the enclosure 14 and mate with corresponding male connectors 21 attached to the cables 20A and 20B. A bus bar 32 extends out from one side of the enclosure 14 and includes a nut 33 for clamping onto a ground wire (not shown).

FIG. 2B shows an alternative embodiment where a two-hole compression-clamped lug 37 is attached to both bus bar 32 and a second bolt 35B coupled to the suppression device 12 via nuts 35A. The second bolt 35B is electrically coupled to the same bus bar 32 inside of enclosure 14. The two bolts 32 and 35B provide the compression-clamped lug 37 with further structural support and additional electrical conductivity.

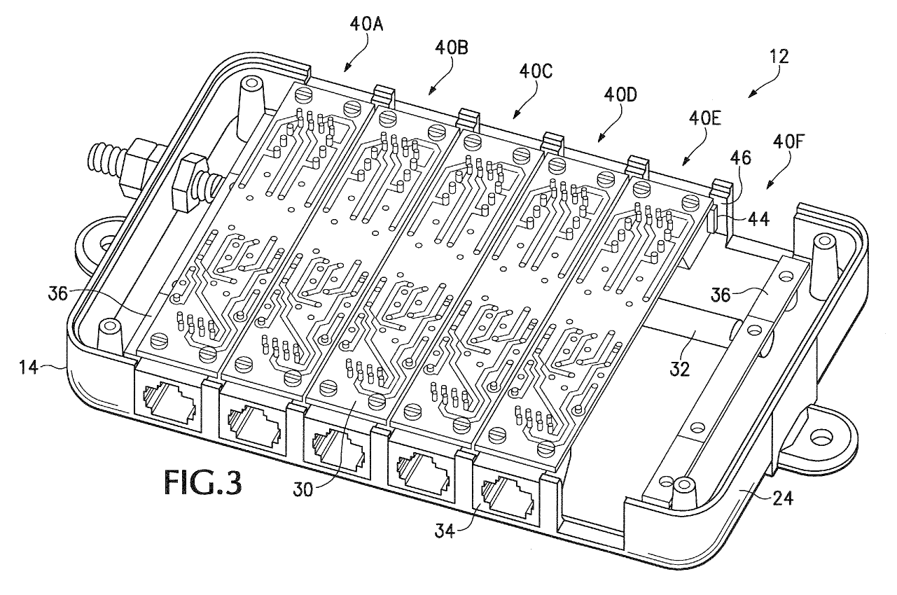

FIG. 3 shows the surge suppression device 12 with the top lid 18 removed. The specific embodiment of the surge suppression device 12 shown in FIG. 3 is sized to contain six slots 40A-40F each capable of receiving an associated surge suppression module 30. However, the surge suppression device 12 can be sized to contain more or less slots or sized to contain surge suppression modules 30 having different lengths and widths.

Slots 40A-40E are shown populated with surge suppression modules 30 and one of the slots 40F is shown empty with no inserted surge suppression module 30. The multiple surge suppression modules 30 insert side-by-side in a co-planar row and extend longitudinally inside the enclosure 14. Any number of the slots 40 can be populated with suppression modules 30. This allows a customer to purchase only the number of surge suppression modules 30 currently required for their particular operation and, if required, expand to add additional cable connections and modules 30 in the future.

In one alternative embodiment, the surge suppression modules 30 contain circuitry for providing surge suppression for Ethernet and/or Power over Ethernet cables 20. One example of this embodiment is described below and may require wider surge suppression modules than the modules 30 shown in FIG. 3. For example, the Ethernet and/or Power over Ethernet modules can be up to twice as wide as the modules 30 shown in FIG. 3.

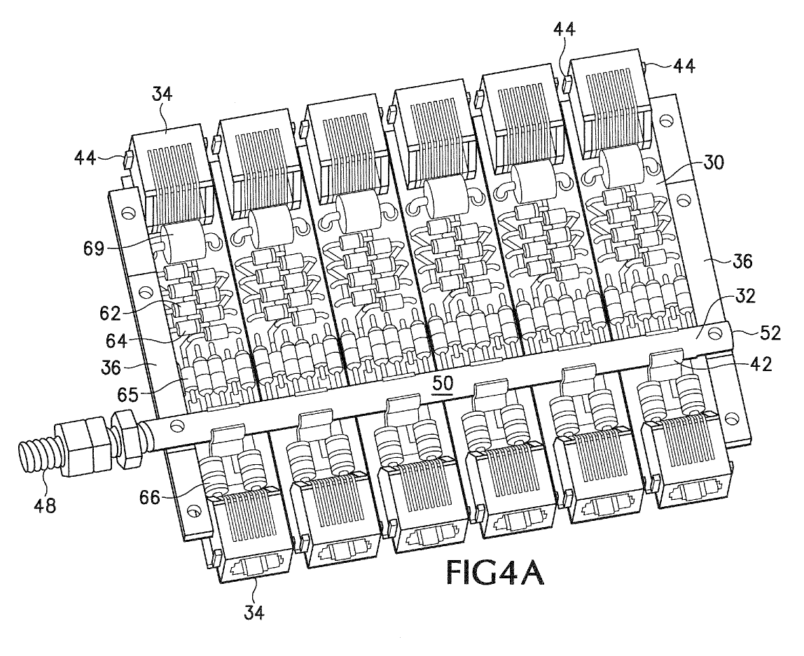

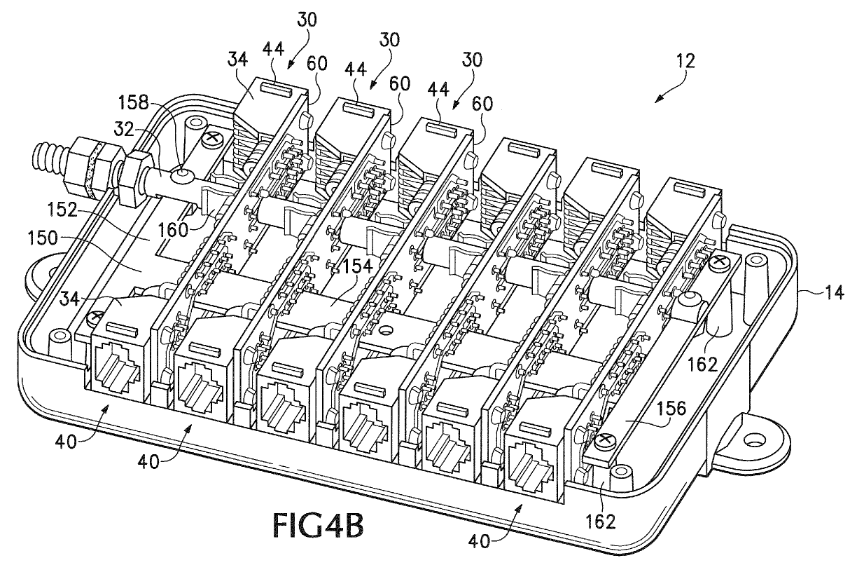

Referring to FIGS. 3 and 4A, the surge suppression modules 30 are inserted vertically downward into the slots 40 until a clip 42 on a bottom side of the surge suppression modules 30 (FIG. 4A) attaches onto the bus bar 32. Tabs 44 extend laterally out from opposite sides of the connectors 34. When the surge suppression module 30 is inserted into one of the slots 40, the tabs 44 seat against an inside walls 46 of the enclosure 14 while at the same time the clip 42 attaches onto the bus bar 32. This provides three separate anchor points for the surge suppression modules 30 inside the enclosure 14.

The clip 42 electrically connects the surge suppression circuitry 62 on the surge suppression module 30 to ground while also securely holding the surge suppression module 30 inside the enclosure 14. In one embodiment, the connectors 34 are RJ-45 female telecommunication connectors used for T1 telecommunication cables. However, other type of connectors can also be used.

The surge suppression arrangement described above allows individual surge suppression modules 30 to be inserted and removed from the slots 40A-40F without disrupting the electrical connections of the other surge suppression modules 30 coupled to the bus bar 32 or disrupting the operation of the data transmission in the cables 20A and 20B connected to those modules (FIG. 1). For example, if one of the surge suppression modules 30 is damaged or destroyed during a power surge condition, the damaged unit 30 can be removed and another surge suppression module 30 inserted without disrupting the other surge suppression modules 30 that are currently inserted and operating in the enclosure 14.

The bus bar in one embodiment is an elongated rod 50 that includes a first end 48 that extends from one side of the enclosure 14 as shown in FIGS. 1 and 2. A round central body section of rod 50 extends along a bottom side of the units 30 and a second end 52 is suspended above the enclosure 14 by a support plate 36. The support plates 36 are attached in a raised position at opposites ends of the bottom portion 24 of the enclosure 14. The bus bar 32 is then attached at opposite ends in a suspended manner to the support plates 36. The bus bar 32 then operates to suspend and hold the surge suppression modules 30 inside the enclosure 14 while also providing an electrical connection to ground.

FIG. 4B shows an alternative embodiment of the surge suppression device 12 where the surge suppression modules 30 are mounted on their sides in a back-to-front arrangement.

In this embodiment, the slots 40 are sized to receive the side orientated connectors 34 with the circuit boards 60 also lying vertically on their sides. The tabs 44 seat inside of mating 10 tabs (not shown) extending up from the bottom and top of the slots 40.

The bus bar 32 is placed under the circuit boards 60 such that the longitudinal axis of the bus bar 32 is perpendicular with the longitudinal axis of the modules 30. The clips 160 connect to bus bar 32. The bus platform 150 is electrically coupled to the bus bar 32 by a screw 158.

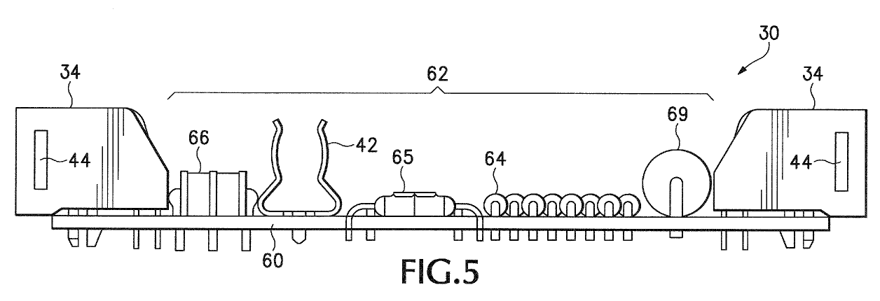

FIG. 5 shows an isolated side view for one of the surge suppression modules 30.

Referring to FIGS. 3, 4A and 5, the surge suppression modules 30 include a circuit board 60 containing surge suppression circuitry 62. The connectors 34 are coupled on opposite ends of the circuit board 60. The clip 42 is attached to the circuit board 60 and as described above electrically couples the surge suppression circuitry 62 to the bus bar 32. The clip 42 in one embodiment is the same shape as a fuse clip typically used for connecting to 0.25 inch fuses, similar to the type used in automobiles. The circuit board 60 is an elongated rectangular shape that extends from a front end to a back end inside the enclosure 14 and is approximately 9 centimeters long and 2 centimeters wide.

The surge suppression circuitry 62 is configured to direct power surges detected on the cables 20 (FIG. 1) to the bus bar 32 during a power surge condition. Gas tubes 66 are located adjacent to the clip 42 to provide a short path to ground. Resistors 65 are arranged longitudinally in a row and diodes 64 are arranged in an interleaved manner in two columns. A SAD 69 is located between the diodes 64 and the connector 34.

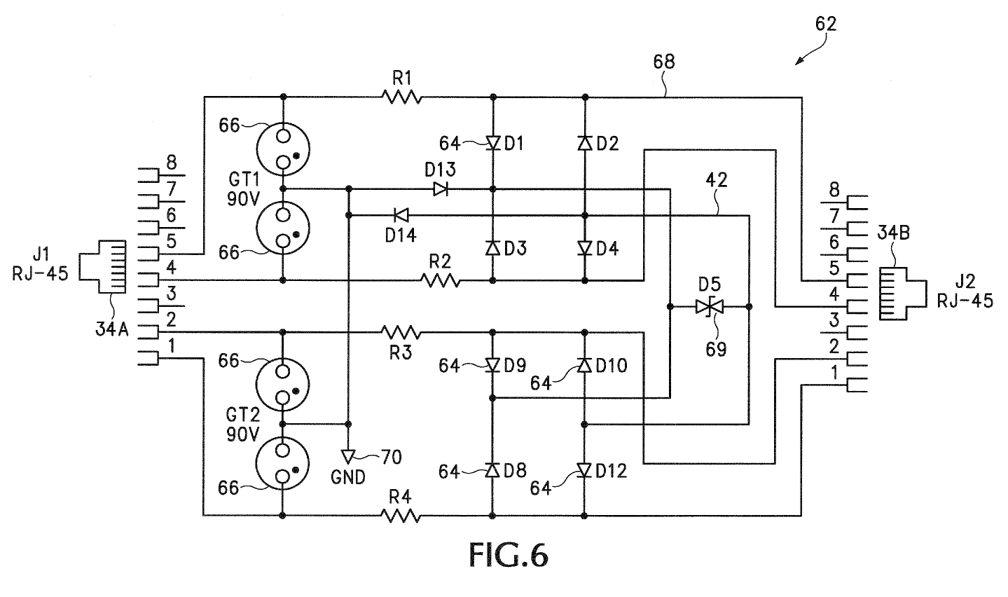

FIG. 6 is a circuit diagram of the surge suppression circuitry 62. The surge suppression circuitry 62 provides for suppression clamping of electrical transients (increases in voltage above the designed threshold). The primary electrical transient circuit 62 utilizes a parallel combination of Silicon Avalanche Diode (SAD) 69 and gas tubes 66. Combining SAD 69 in parallel with gas tubes 66 serves to increase the total system clamping current handling and power/energy dissipation capability. The SAD 69 has a rated voltage of 30 volts +/−5% at 5 milliamperes. The total energy dissipation capability of the surge suppression circuit 62 is around 15 joules of SAD and 10 kiloAmperes of gas tube. The surge suppression circuitry 62 described above can also be replaced with other voltage parts for different applications. For example, SAD 69 could have a rated voltage of 7.5 volts instead of 30 volts.

For example, a conductor 68 provides a connection between the T1 cables 20A and 20B attached to connectors 34A and 34B. When a power surge generates a voltage above an over voltage threshold value, the gas tube 66 and SAD 69 each conduct coupling the conductor 68 to connector 42 which in this case is coupled to ground 70 via the bus bar 32 (FIG. 4A). The power surge is directed to ground. When the power surge condition subsides, the conductivity path in connection 68 between connector 34A and 34B is reestablished.

Thus, a single enclosure 14 contains multiple data cable surge suppression modules 30 that are all individually replaceable without disturbing the operation of other operating surge suppression modules. The operation of other T1 or E1 data cables 20A and 20B connected to the other the surge suppression modules 30 will not be disrupted when one of the surge suppression modules 30 is replaced.

### Power Over Ethernet (PoE)

Alternative embodiments can provide surge suppression for Internet Protocol (IP) network connections that provide both data and power over the same cable. IP networks that include a power sourcing device and a power receiving device that also receive IP data over the same cabling are referred to generally as Power over Ethernet (PoE) systems. The PoE power sourcing equipment can include routers, switches, gateways, call concentrators, or any other type of network processing equipment that provides power as well as transferring Internet Protocol (IP) packets over the same network cable.

The devices that receive power from the sourcing device can be any network device that needs data cable power that may or may not also receive and transmit Internet Protocol packets. For example, Voice over IP (VoIP) phones, switches, routers, computer terminals, etc. It should be understood that referring to Power over Ethernet (PoE) can, but does not necessarily require, that an Ethernet protocol be used when transferring packets over an IP network.

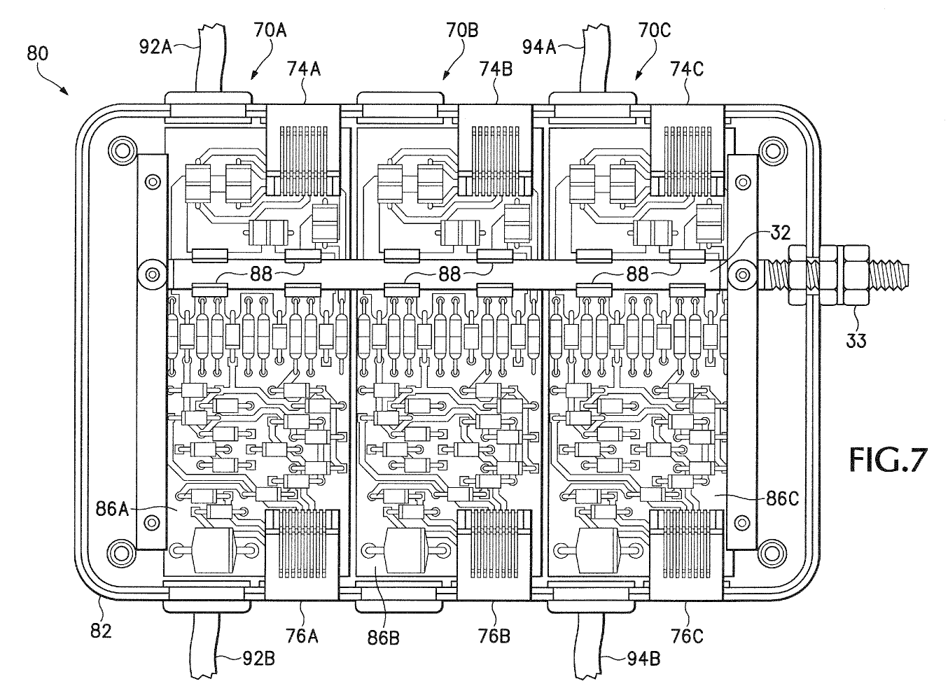

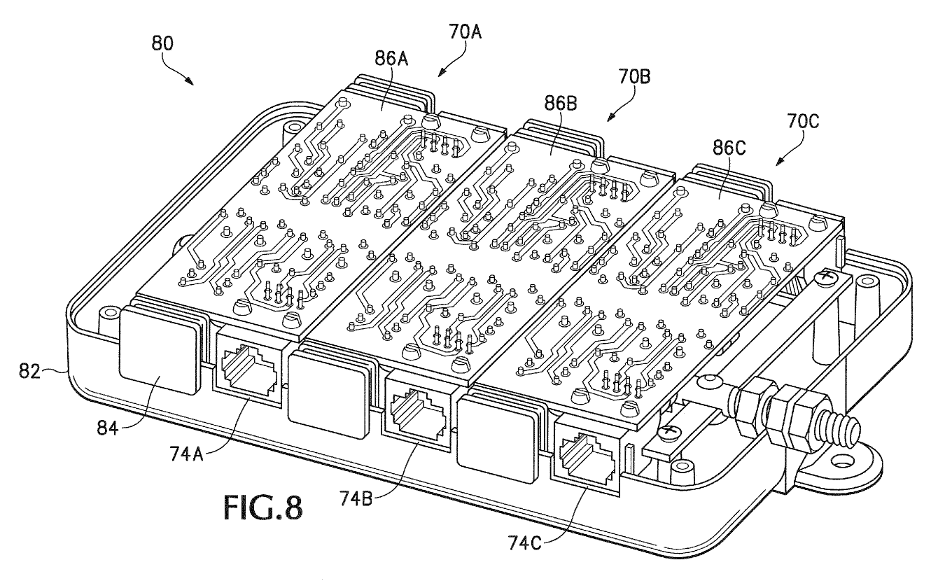

FIGS. 7 and 8 show a top and bottom view, respectively, of a PoE surge suppression device 80. The PoE surge suppression device 80 includes an enclosure 82 that is the same or similar to the enclosure 14 previously shown in FIG. 1. The PoE surge suppression device 80 is attached to different IP network cables 92 and 94 to prevent electrical surges from damaging electrical equipment used in Internet Protocol (IP) networks. For example, the cables 92 and 94 that connect to device 80 can be Ethernet communication cables. However, the PoE surge suppression module 80 is easily adapted to accept any other type of cabling for any other type electrical equipment or IP network. In another embodiment shown below, connectors 74 and 76 can be replaced with hardwired terminals that have screws that clamp directly onto the wires in the Ethernet cables 92 and 94.

A first part of each cable 92A and 94A is connected to the front end of a surge suppression module 86A and 86C, respectively. A second part of each cable 92B and 94B are connected to a back end of the surge suppression modules 86A and 86C, respectively. The multiple individual surge suppression modules 86A-86C can be located inside the surge suppression device 80 for directing electrical surges on either end of the different cables 92 and 94 to ground. This prevents the electrical surge from reaching and destroying electrical equipment connected to the cables 92 and 94.

Multiple female connectors 74 and 76 are aligned with both the front and back end of the enclosure 82 and mate with corresponding male connectors (not shown) attached to the cables 92 and 94. A bus bar 32, similar to that described above in FIGS. 1-3, extends out from one side of the enclosure 80 and includes a same nut 33 for clamping onto a ground wire (not shown).

FIG. 8 shows the bottom side of the surge suppression device 80 with the lid removed. As previously described above in FIGS. 1-3, the surge suppression device 80 is sized to contain six slots 70 each capable of receiving an associated surge suppression module 30 (FIG. 2). However, the PoE surge suppression modules 86A-86C has a wider profile that take up the space of two adjacent slots 70. Accordingly, every other slot 70 in the surge suppression device 80 is plugged with a cap 84.

Any combination of the slots 70 can be used for either the suppression modules 30 described above in FIGS. 1-3 and/or the PoE surge suppression modules 86 shown in FIGS. 7 and 8. This allows a customer to only purchase the number and type of surge suppression modules 30 and 86 required for particular applications, and if required, expand to add additional cable connections and modules 30 and/or 86 in the future.

Other than the contained surge suppression circuitry, the mechanical operation of the surge suppression modules 86 operate substantially the same as the modules 30 described above in FIGS. 1-3. The modules 86 are inserted vertically downward into the slots 70 until clips 88 on the surge suppression modules 86 attach onto the bus bar 32. Tabs extend laterally out from opposite sides of the connectors 74 and 76. When the surge suppression module 86 is inserted into one of the slots 70, the tabs seat against an inside walls of the enclosure 82 while at the same time the clips 88 attach onto the bus bar 32. This provides four separate anchor points for the surge suppression modules 86 inside the enclosure 80.

The clips 88 electrically connect the surge suppression circuitry on the surge suppression modules 86 to ground while also securely holding the surge suppression modules 86 inside the enclosure 80. In one embodiment, the connectors 74 and 76 are RJ-45 female telecommunication connectors used for receiving Ethernet cable connectors. However, other type of connectors can also be used.

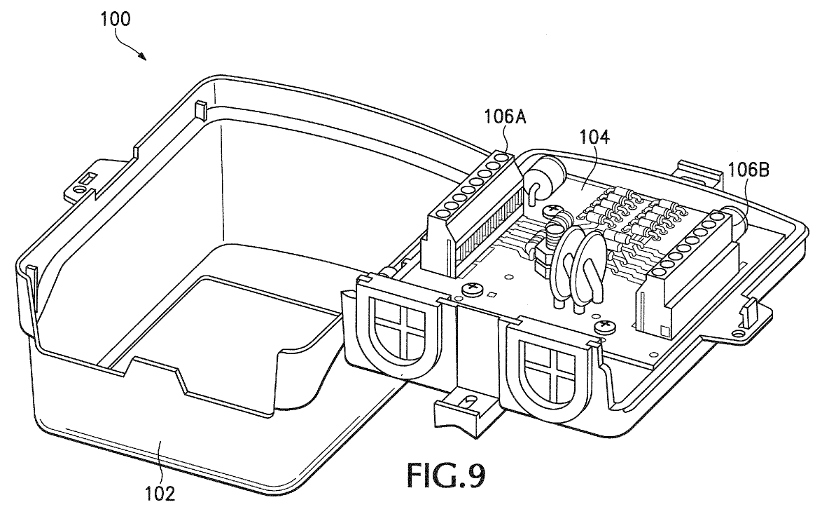

FIG. 9 shows an alternative embodiment of a PoE surge suppression device 100 that includes a weatherproof enclosure 102. The weatherproof enclosure 102 may be made from any type of weather resistant material such as fiberglass, plastic, metal, etc. and allows the surge PoE suppression device 100 to be installed outside, such as on the outside of a residence or other building.

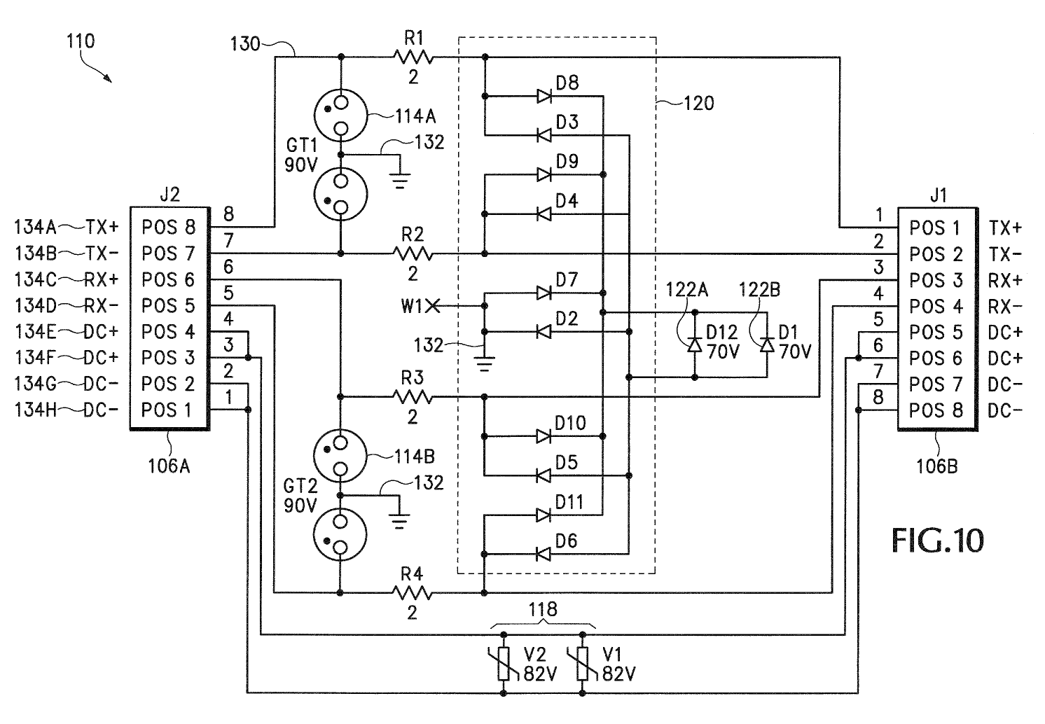

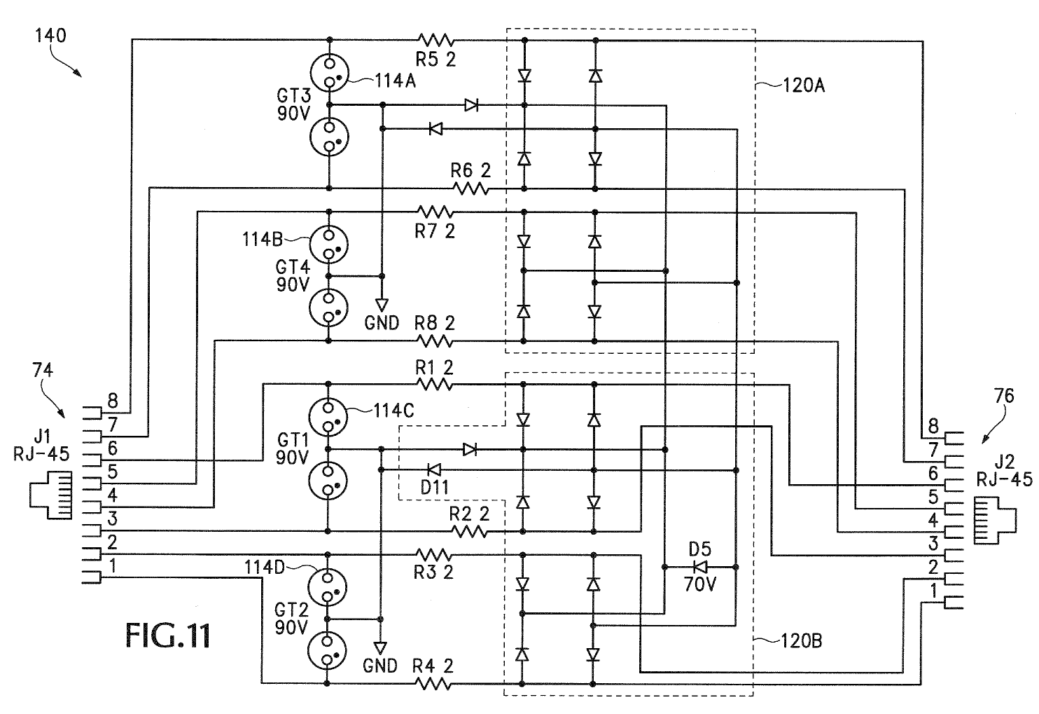

As will be described below in FIGS. 10 and 11, the surge suppression circuitry used in the weatherproof PoE device 100 is similar to the surge suppression circuitry used in the modular PoE device 80 shown above in FIGS. 7 and 8. However, there are a few distinctions that will be explained in more detail below. The PoE surge suppression module 104 in the weatherproof device 100 also includes screw-in terminals 106A and 106B that allows separate wires from an Ethernet cable to be individually inserted and screwed into the separate connections.

### Improved Surge Suppression

FIG. 10 shows a circuit diagram for the PoE surge suppression circuitry used in the PoE surge suppression device 100 shown in FIG. 9. FIG. 11 shows the circuit diagram for the PoE surge suppression circuitry used in the modules 86 in the modular PoE surge suppression device 80 shown in FIGS. 7 and 8. Many of the circuit elements and much of the circuit configuration is the same in both FIGS. 10 and 11. However, the modular circuitry in FIG. 11 includes additional surge suppression circuitry coupled between additional Receive differential pairs (Rx+ and Rx−) and the DC power signals. Accordingly, the operation of the circuit in FIG. 10 will primarily be described but will also refer to the similar elements and circuitry in FIG. 11.

The surge suppression circuitry 110 in FIGS. 10 and 140 in FIG. 11 provides for suppression clamping of electrical transients (increases in voltage above a designed threshold). The electrical transient circuit 110 utilizes a parallel combination of Silicon Avalanche Diode (SAD) 122A and 122B and gas tubes 114. Combining SADs 122 in parallel with gas tubes 114 serves to increase the total current handling and power/energy dissipation capability. The surge suppression circuitry described above can also be replaced with other voltage parts for different applications.

The IP field wiring or other IP cabling connected to an IP switch, IP router, server, etc. may be connected to terminal 106A. The network cabling connected to the one or more devices to be powered by the IP switch, such as a VoIP phone, would be connected to terminal 106B. Separate PoE surge suppression devices 80 (FIG. 7) or 100 (FIG. 9) could be coupled at the power supplying IP device end of the Ethernet cable and at the power receiving device end of the Ethernet cable, or at any other location inbetween.

During normal data transmission and power operations, the surge suppression circuitry 110 is passive. Data is transmitted over the differential transmit pair TX+/TX− (134A, 134B) and data is received over the differential receive pair RX+/RX− (134C,134D). From a power supplying device, power can be either over-laid with the TX+/TX− data signaling or alternatively transmitted separately over the DC+/DC− conductors (134E-134H).

Of particular interest are the Metal Oxide Varistors (MOVs) 118 attached across the dedicated DC+ and DC− connections 134E-134H. The MOVs 118 are used instead of gas tube circuits 114 to allow more power to be passed across the power lines DC+ and DC− 134E-134H. The gas tubes 114 may have a tendency not to turn off after conducting a surge when too much power is applied over the TX and RX conductors. If a particular application attempts to provide too much power to the endpoint, the gas tubes 114 could then fail to turn off and deactivate the connections. However, using the MOVs 118 across the TX and RX data terminals may create too much capacitance over the data lines.

Accordingly, the MOVs 118 allow more power to be provided over the dedicated power conductors 134E-134H, while at the same time allowing the gas tubes circuits 114 to provide reduced capacitance surge protection to the TX and RX data conductors 134A-134D.

In one example, a conductor 130 provides a connection between the TX+ connector 134A in the TX+/TX− differential signal pair between a pair of Ethernet cables. When an electrical surge occurs on conductor 130, one of the gas tubes 114 starts conducting at a relatively large voltage turn-on value, such as around 400-500 peak voltage. Until the gas tubes 114 turn on, the Silicon Avalance Diodes (SADs) 122 clamp the power surge pulling current across the diodes in the bridge circuit 120 and across the SADs 122 in-turn dropping voltage across the resistors R1 and R2. The combination of voltage across the resistor R1 and the voltage across the diodes 122 force the gas tube 114 to break down and short the power surge to ground.

The bridge circuit 120 operates to reduce the capacitance that would normally be applied to the data lines by the SADs 122. To provide a lower surge clamping voltage, Schottky rectifier diodes are used in the diode bridge circuit 120. This contrasts with the commonly used 1N400X rectifier diodes that are conventionally used.

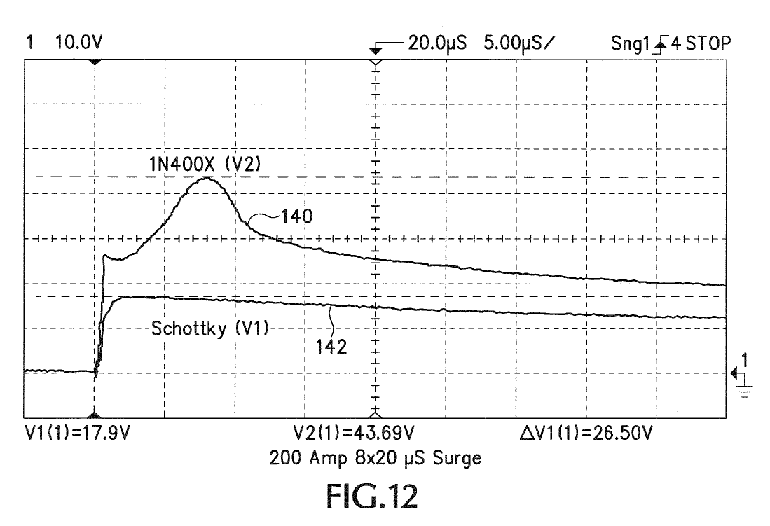

To explain in further detail, FIG. 12 shows a graph comparing the signal response for both a convention rectifier 1N diode and a Schottky diode. The horizontal X-axis of the graph represents time in 20 microsecond intervals and the vertical Y-axis represents voltage in 10 volt intervals. Curve 140 represents the signal response for the conventional 1N rectifier diode and curve 142 represents the signal response for the Schottky diode from a 200 Amp 8×20 microsecond power surge.

Under a surge current environment, when the forward current in a 1N400X diode exceeds 400 Amps, the forward voltage drop across the 1N400X increases exponentially. In contrast to this, when the forward current in a Schottky rectifier diode exceeds 400 Amps, the forward voltage continues to rise linearly up to a much higher current level. This improved response to high surge current levels allows a Schottky rectifier based surge suppressor to outperform a 1N400X based surge suppressor.

As shown in FIG. 12, when the power surge is applied to the two diodes, the peak for the 1N diode curve 140 rises to 43.69 volts. However, the peak for the Schottky diode curve 142 only rises to 17.19 volts. The responses shown in the two curves 140 and 142 show that for large power surges, the Schottky diode is superior in clamping the power surge to a lower voltage level. Accordingly, the lower peak voltage allowed by the Schottky diode improves the high voltage protection provided by the PoE circuits shows in FIGS. 10 and 11. In other words, the Schottky diodes have a lower voltage drop at high currents and accordingly clamp the power surge at a lower voltage level.

Accordingly, in one embodiment, Schottky diodes are used as the diodes in the bridge circuits 120 and 120A and 120B, in FIGS. 10 and 11, respectively. Different types of conventional Schottky rectifier diodes can be used according to the particular application. It has also been discovered that conventional Schottky diodes from different manufactures provide similar low voltage clamping characteristics. Accordingly, Schottky diodes from different manufacturers can alternatively be used.

Having described and illustrated the principles of the invention in a preferred embodiment thereof, it should be apparent that the invention may be modified in arrangement and detail without departing from such principles. We claim all modifications and variation coming within the spirit and scope of the following claims.

1. A surge suppression unit, comprising:
connection circuitry for coupling the surge suppression unit to a communication cable; and
surge suppression circuitry including at least one Silicon Avalanche Diode (SAD) directing a power surge on the communication cable to ground.

2. The surge suppression unit according to claim 1 wherein the surge suppression circuitry further comprises a gas tube suppression element coupled between a communication path and ground.

3. The surge suppression unit according to claim 2 wherein the surge suppression circuitry comprises:
a diode bridge circuit coupled to the communication path;
a resistor located series within the communication path.

4. The surge suppression unit according to claim 3 wherein diodes in the diode bridge circuit are SADs.

5. The surge suppression unit according to claim 3 wherein the SAD is coupled between the diode bridge circuit and ground.

6. The surge suppression unit according to claim 3 wherein the SAD clamps the power surge, prior to the gas tube turning on, pulling current across the diode bridge circuit and dropping voltage across the resistor and the SAD so that the combination of voltage drops across the resistor and the SAD force the gas tube to short the power surge to ground.

7. The surge suppression unit according to claim 1 wherein the surge suppression circuitry comprises:
a first diode bridge circuit coupled between a transmit data path in the communication cable and the SAD; and
a second diode bridge circuit coupled between a receive data path in the communication cable and the SAD.

8. The surge suppression unit according to claim 7 wherein the surge suppression circuitry comprises:
a first gas tube suppression element coupled between a differential signal pair for the transmit data path and ground; and
a second gas tube suppression element coupled between a differential signal pair for the receive data path and ground.

9. The surge suppression unit according to claim 2 wherein the surge suppression circuitry further comprises a Metal Oxide Varistor (MOV) coupled between a dedicates positive Direct Current (DC) power line and a dedicated negative DC power line in the communication cable.

10. The surge suppression unit according to claim 9 wherein the MOV allows more power to be pass before activating than the gas tube and the gas tube has less capacitance than the MOV.

11. The surge suppression unit according to claim 1 wherein the communication cable is an Ethernet cable.

12. A surge suppression unit, comprising:
an enclosure including multiple slots;
multiple detachable surge suppression modules configured for inserting into and detaching from the enclosure slots, the surge suppression modules each including connectors for connecting to different communication cables and surge suppression circuitry for suppressing power surges on the communication cables.

13. The surge suppression unit of claim 12 including a bus bar that extends across the enclosure that attaches to each of the surge suppression modules.

14. The surge suppression unit of claim 13 including clips on each of the surge suppression modules that comparatively and electrically attach to the bus bar.

15. The surge suppression unit of claim 12 wherein the connectors on each surge suppression module insert into openings on opposite sides of the enclosure.

16. The surge suppression unit of claim 15 wherein the connectors comprise RJ-45 connectors.

17. The surge suppression unit of claim 12 wherein at least one of the surge suppression modules is double sized using two enclosure slots where openings in a first one of the two enclosure slots is not used and openings in a second one of the two enclosure slots receive the connectors for the double sized surge suppression module.

18. The surge suppression unit of claim 12 wherein the surge suppression modules are inserted on their sides front-to-back into the enclosure and a bus bar extends directly through the surge suppression modules.

19. The surge suppression unit of claim 12 wherein the surge suppression circuitry includes at least one Silicon Avalanche Diode (SAD) directing power surges on the connected communication cable to ground.

20. The surge suppression unit according to claim 12 wherein the surge suppression circuitry includes a gas tube suppression element coupled in parallel with the SAD between a communication path in the connected communication cable and ground.

21. The surge suppression unit according to claim 20 wherein the surge suppression circuitry comprises a diode bridge circuit of SADs coupled to the communication path.

22. The surge suppression unit according to claim 21 wherein the SADs clamp the power surge, prior to the gas tube turning on, pulling current across the diode bridge circuit forcing the gas tube to short the power surge to ground.

23. The surge suppression unit according to claim 19 wherein the surge suppression circuitry comprises:
a first diode bridge circuit coupled to a transmit communication path in the communication cable; and
a second diode bridge circuit coupled to a receive communication path in the communication cable.

24. The surge suppression unit according to claim 23 wherein the surge suppression circuitry comprises:
a first gas tube suppression element coupled between a differential signal pair of the transmit communication path and ground; and
a second gas tube suppression element coupled between a differential signal pair of the receive communication path and ground.

25. The surge suppression unit according to claim 24 wherein the surge suppression circuitry further comprises a Metal Oxide Varistor (MOV) coupled between a positive Direct Current (DC) power line and a negative DC power line in the communication cable.

26. The surge suppression unit of claim 12 wherein the surge suppression circuitry comprises a diode bridge circuit of Schottky rectifier diodes.
